(19) United States
(12) Patent Application Publication
(10) Pub. No.: US 2012/0228981 A1
(43) Pub. Date: Sep. 13, 2012

(54) Electric Machine

(75) Inventor: Gurakuq Dajaku, Neubiberg (DE)

(73) Assignee: FEAAM GmbH, Neubiberg (DE)

(21) Appl. No.: 13/389,220

(22) PCT Filed: Aug. 4, 2010
(86) PCT No.: PCT/EP10/61364

§ 371 Date: May 21, 2012

(30) Foreign Application Priority Data
Aug. 4, 2009 (DE) 10 2009 036 034.4

(51) Int. Cl. H02K 3/28

(52) U.S. Cl. 310/195

(57) ABSTRACT

The invention relates to an electric machine comprising a stator (8) and a rotor (9). The stator comprises grooves (1, 2) for receiving at least two coils of an electric winding. The first coil comprises a first winding number (n1) in a first groove and a second winding number (n2) in a second groove (2). The second coil comprises a first winding number (n1′) in a first groove and a second winding number (n2′) in a second groove (2).

The present invention relates to an electric machine.

Electric machines typically comprise a stator that is stationary with respect to a housing as well as a rotor that is movable relative to the stator. The rotor can be seated rotatably relative to the stator or can be movable linearly with respect to it. Electric machines are classified among the electromechanical energy converters. They can be operated as motors or as generators.

For example, electric machines can be used for driving motor vehicles. In this and other applications it can be advantageous to achieve certain characteristics in the electric machine's operating behavior. These can include the torque, the acoustic properties, the losses in the core, the windings and the magnet.

A stator of an electric machine with concentrated windings is distinguished from one with distributed windings by a compact design. Different pole pair numbers can be combined with different numbers of grooves in the stator. A pole pair number is understood to mean the number of pole pairs in the rotor. The grooves in the stator are used to accommodate the windings. Each magnetic pole pair in the rotor normally comprises two magnetic poles, a north pole and a south pole.

The document US 2007/0194650 A1 describes an electric machine with twelve grooves and ten poles. In such a machine, the magnetomotive force produced in operation is not distributed according to a sinusoidal wave. Instead, an analysis of the magnetomotive force and its harmonic components, by a Fourier decomposition for example, shows clearly that numerous undesired harmonic components appear. All harmonic components other than that which is used as the working harmonic of the electric machine are undesired because they can cause losses and also can cause undesired acoustic impairment.

The fundamental wave is not necessarily the working harmonic in machines with concentrated windings. It can instead be advantageous to use a harmonic component of the magnetomotive force of a higher order as the working harmonic.

For example, the fifth or seventh harmonic can be used as the working harmonic in an electric machine having a stator with concentrated windings, wherein two adjacent teeth are furnished with coils of one phase winding and opposite winding directions. In the basic form, this yields a machine with 12 grooves and 10 poles or 12 grooves and 14 poles. Integer multiples of the number of grooves and the number of poles are equally possible.

The problem of the present invention is to achieve a flexible reduction of the subharmonics in an electric machine with a low expense. The term subharmonic is relative to the working harmonic in the present case.

The problem is solved according to the invention by an electric machine with the characteristics of the independent claim. Configurations and refinements are specified in the respective dependent claims.

In one embodiment of the proposed principle, the electric machine comprises a stator and a rotor that is movable relative to the stator. The stator comprises grooves for accommodating coils of an electrical winding. In a first groove, a first coil has a first number of turns. In a different groove, the same coil has a second number of turns different from the first one. A second coil has a first number of turns in the first groove. In the other groove of the stator, this second coil likewise has a second number of turns different from the first one.

The proposed embodiment of the winding with coils having different numbers of turns in different grooves of the stator makes it possible, for instance, to reduce the first subharmonic of the Fourier decomposition of the magnetomotive force significantly or to cause it to disappear. A high degree of flexibility is provided by the combination of several coils with one another that can be realized with identical or different turn number ratios.

No modifications of the stator geometry or the rotor are necessary for the proposed principle.

The respective coil is preferably introduced into the groove from a different main side of the stator than that from which it leaves the groove. In other words, the connections of the coil are not formed in the conventional manner on a common side of the stator, i.e. the same main side, but rather on different main sides of the stator.

For example, the main side of the stator for a rotating electric machine has a surface normal in the axial direction.

The second number of turns is preferably greater than the first number of turns.

The first number of turns n1 is preferably between 50% inclusively and 100%, non-inclusively of the second number of turns n2. In other words, the ratio of the first number of turns n1 to the second number of turns n2 is greater than or equal to 0.5 and less than 1, with the difference of the numbers of turns being equal to 1

n2−n1=1.

If one refers to the total number of turns of the respective first coils with the first number of turns, i.e., the total number of turns of the respective first coils in the first groove as n1*, and the total number of turns of the respective first coils having the second number of turns, i.e. the total number of turns of the respective first coils in the second groove as n2*, then

n1*=n2*−1.

In addition, the ratio of the first total number of turns n1* to the second total number of turns n2* is greater than or equal to 0.5 and less than 1, with n1*/n2*=2n1/2n2.

The same applies to the respective second coils, which can be arranged in a different winding plane than the first coils.

For example, the respective coil is inserted into the stator in the second groove and runs through the second groove until it exits on the opposite main side of the stator. Then there is another complete turn of 360° around a tooth which the second groove contacts. The turn in this case is led through the first groove and back through the second groove. In this way the coil exits on a different main side of the stator from that on which it enters. Thereby the second number of turns n2 is twice the first number of turns n1. In other words, the first number of turns n1 is 50% of the second number of turns n2 in the second groove.

A second coil in these grooves can have the same numbers of turns as the first coil, or a different turn ratio. For example, a number of turns of 2 in the first groove and 3 in the second groove can be provided by an additional turn relative to the first coil.

The first and second coils are advantageously assigned to the same electrical phase of the machine.

The first and second coils can also be connected to one another in series or in parallel.

A third or more coils can of course also be provided in these grooves in order to further increase the flexibility in achieving a desired number of turns ratio.

A coil with the same number of turns is preferably arranged in the first groove in addition to the above-mentioned coil. In this embodiment, another coil with the same number of turns is arranged in the second groove. These two additional coils are preferably wound around a different tooth, however, than are the coils that are referred to as the first and second coils. These two coils, also referred to as first coils, are preferably arranged in one plane.

In one embodiment, no differing numbers of turns are combined in one groove within one plane. Instead, coils, each with an identical number of turns, are placed in a groove, which preferably applies to all grooves of the stator.

In one embodiment, all coils in the first groove are from the same phase winding and the coils in the second groove are from a different phase winding.

One phase winding of the electric machine is assigned to a respective electrical phase of the electric machine, so that different phase windings are assigned to different electrical phases.

For example, those coils that are arranged in one groove and are from the same phase winding have the first number of turns in this groove. In those grooves in which coils of different phase windings are placed, they have the same number of turns in this groove. The grooves in the stator with first and second numbers of turns preferably alternate periodically along the stator in one movement direction of the rotor.

Coils of the same phase winding can preferably have an identical direction of current flow in the respective groove. Adjacent coils of the same phase winding can also be wound in opposite winding directions.

Coils of different phase windings have opposite directions of current flow in these grooves. The neighboring coils of different phase winding can be wound with an identical winding direction.

The stator preferably has a three-phase winding comprising three phase windings, each assigned to a different electrical phase. The associated electrical system is a three-phase system with three phases shifted with respect to one another by 120° each.

The stator is preferably constructed as a stator with concentrated windings. Two neighboring teeth of the stator, each formed between neighboring grooves of the stator, have coils of one phase winding and opposite winding directions.

The grooves in the stator are distributed equidistantly in one embodiment.

All teeth can have the same geometry.

All grooves in the stator can likewise have the same geometry.

The proposed principle is preferably applicable in an electric machine with 12 grooves in the stator and 10 magnetic poles in the rotor. The electric machine can alternatively have 12 grooves in the stator and 14 magnetic poles in the rotor. Also alternatively, the same integer multiple of the number of grooves and the number of poles can be provided.

The following table shows general examples of the possible machine topologies. The letter n represents the number of coils of one phase winding around adjacent teeth, 2p represents the number of poles in the rotor and Z represents the number of teeth or grooves. The minimum number of teeth and poles for concentrated windings is specified in each case. Integer multiples of the number of grooves and the number of poles are possible.

| | 2 phase windings | | 3 phase windings | | 4 phase windings | | 5 phase windings | |
|---|---|---|---|---|---|---|---|---|
| | single-layer | double-layer | single-layer | double-layer | single-layer | double-layer | single-layer | double-layer |
| | winding | winding | winding | winding | winding | winding | winding | winding |
| n = 1 | Z = 8 | Z = 4 | Z = 12 | Z = 6 | Z = 16 | Z = 8 | Z = 20 | Z = 5 |
| | 2p = 2/6/10 | 2p = 2/6 | 2p = 2/10/14 | 2p = 2/10 | 2p = 14/18 | 2p = 6/10 | 2p = 18/22 | 2p = 4/6 |
| | | | or | or | | | | or |
| | | | Z = 6 | Z = 3 | | | | Z = 10 |
| | | | 2p = 2/4/8 | 2p = 2/4 | | | | 2p = 6/14 |
| n = 2 | Z = 16 | Z = 8 | Z = 24 | Z = 12 | Z = 32 | Z = 16 | Z = 40 | Z = 10 |
| | 2p = 2/14/18 | 2p = 6/10 | 2p = 2/22/26 | 2p = 10/14 | 2p = 30/34 | 2p = 14/18 | 2p = 38/42 | 2p = 8/12 |
| | | | | or | | | | or |
| | | | | Z = 6 | | | | Z = 20 |
| | | | | 2p = 4/8 | | | | 2p = 18/22 |
| n = 3 | Z = 24 | Z = 12 | Z = 36 | Z = 18 | Z = 48 | Z = 24 | Z = 60 | Z = 15 |
| | 2p = 2/22/26 | 2p = 10/14 | 2p = 2/34/38 | 2p = 14/22 | 2p = 46/50 | 2p = 22/26 | 2p = 58/22 | 2p = 14/16 |
| | | | | or | | | | or |
| | | | | Z = 9 | | | | Z = 30 |
| | | | | 2p = 8/10 | | | | 2p = 26/34 |
| n = 4 | Z = 32 | Z = 16 | Z = 48 | Z = 12 | Z = 64 | Z = 32 | Z = 80 | Z = 20 |
| | 2p = 2/30/34 | 2p = 14/18 | 2p = 2/46/50 | 2p = 10/14 | 2p = 62/66 | 2p = 30/34 | 2p = 78/82 | 2p = 18/22 |
| | | | | or | | | | or |
| | | | | Z = 24 | | | | Z = 40 |
| | | | | 2p = 22/26 | | | | 2p = 38/42 |

Alternatively or additionally, the electric machine can comprise one of the following types: a linear machine, an axial flux machine, a radial flux machine, an asynchronous machine or a synchronous machine.

The electric machine can be constructed as a machine with an internal rotor or an external rotor.

The rotor of the proposed electric machine can be one of the following types, for example: a cage rotor or a multiple-layer rotor in the case of asynchronous machines, or a permanent magnet rotor in the case of synchronous machines, a rotor with buried magnets or an electrically supplied rotor such as a non-salient pole rotor, a salient pole rotor, a heteropolar rotor or a homopolar rotor.

In one refinement, the stator has a number of grooves that is twice the minimally necessary number of grooves for a given pole pair number p. With respect to this doubling of the grooves in the stator, we refer to the patent application numbered 10 2008 051 047.5 by the same applicant, which was filed at the German Patent and Trademark Office on Oct. 9, 2008. This patent application is incorporated in full herein by reference.

The proposed principle will be described in detail below for several embodiment examples with reference to the drawings. Identical or functionally identical parts bear identical reference numbers therein.

### IN THE DRAWING

FIG. 1 shows a section of a first embodiment example of a stator,

FIG. 2 shows an embodiment example of a coil,

FIG. 3 shows another embodiment example of a coil,

FIG. 4 shows an embodiment example of a rotating electric machine,

FIG. 5 shows a diagram of the magnetomotive force plotted versus the angular position in rad,

FIG. 6 shows a distribution of the magnetomotive force versus the Fourier components,

FIG. 7A shows a refinement of the electric machine of FIG. 4 with compensation windings,

FIG. 7B shows a contrast of the compensation windings and the coils with different numbers of turns in the grooves for one example,

FIG. 8 shows the distribution of the first harmonic of the magnetomotive force according to the embodiment of FIG. 7A,

FIGS. 9 and 10 show diagrams of the magnetomotive force versus the angular position in rad and the Fourier components, respectively,

FIG. 11 shows an example of a comparison of the diagrams of FIG. 6 and FIG. 10,

FIG. 12 shows an embodiment example of an electric machine with 24 grooves and 10 poles,

FIG. 13 shows a refinement with an additional concentrated winding,

FIG. 14 shows the embodiment example of FIG. 13 based on a rotating electric machine,

FIG. 15 shows a diagram of the magnetomotive force plotted versus the angular position in rad for the example of FIG. 14,

FIG. 16 shows an example of a diagram of the magnetomotive force plotted versus the Fourier components for the embodiment of FIG. 14,

FIG. 17 shows the diagram of FIG. 16 compared to a conventional electric machine,

FIG. 18 shows an exemplary refinement of FIG. 1 with grooves of different depths,

FIG. 19 shows an embodiment example of the stator with two superimposed coils according to the proposed principle,

FIG. 20 shows an example of coils constructed one above the other according to the proposed principle in a plan view,

FIG. 21 shows an example of an electric machine with a rotor and a stator with several coils arranged one above another according to the proposed principle,

FIGS. 22 and 23 each show a refinement of the embodiment according to FIG. 19 with more than two coils arranged one above another according to the proposed principle,

FIG. 24 shows an embodiment example of a stator in 24/10 topology with barriers for the magnetic flux,

FIG. 25 shows an embodiment example of a stator combining the embodiments of FIGS. 12 and 22,

FIG. 26 shows an embodiment example of a refinement of the stator according to FIG. 25 with different tooth widths.

Before the proposed principle is described in detail with reference to concrete embodiment examples, there will first be a description of the underlying principle based on only one coil level or only one coil with different numbers of turns.

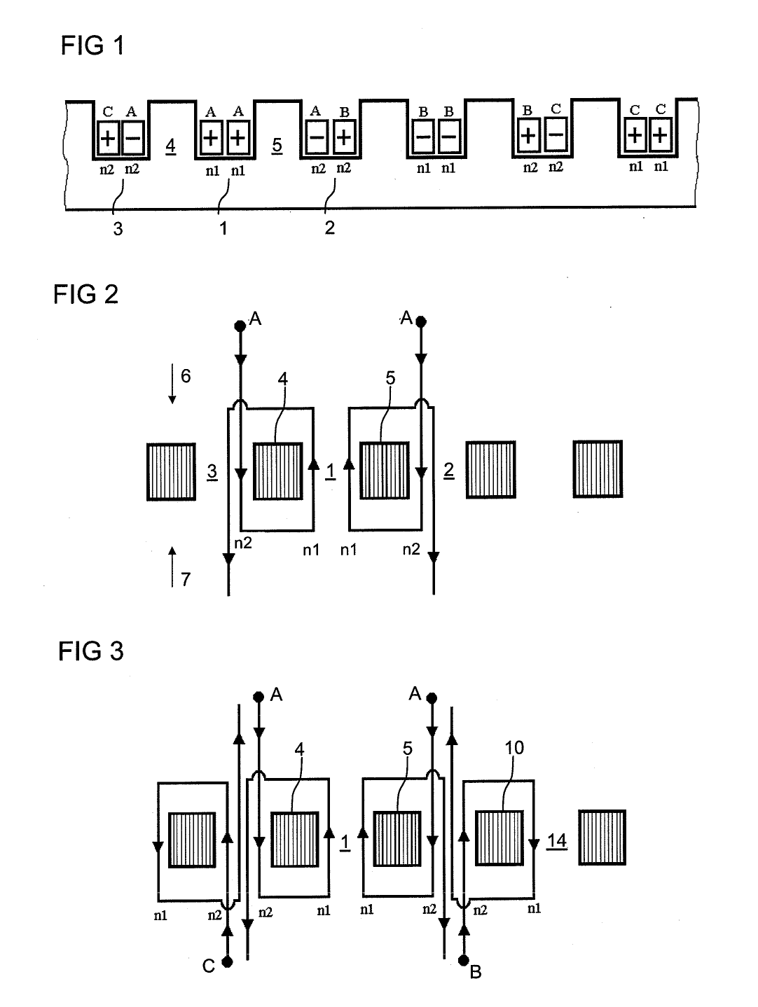

FIG. 1 shows an embodiment example of a stator using a cutout in cross section. The electric machine is configured for the sake of example as a linear machine. A coil of a first phase winding A of an electrical winding is placed in a first groove 1 and a second groove 2. The coil of the phase winding A has a first number of turns n1 in the first groove 1 and the same coil has a second number of turns n2 in the second groove 2. Another coil of the first phase winding A is positioned in the first groove 1 and in the third groove 3 drawn in on the left of it. This additional coil likewise has the number of turns n1 in the first groove 1, while it has the second number of turns n2 in the third groove.

Considered with respect to the winding topology, this is a conventional winding topology as provided in electric machines with 12 grooves, 10 poles and three phases, apart from the above-mentioned numbers of turns, which are arranged in different grooves for equal coils in the present example. The electrical phase windings are labeled A, B, C and are each associated with one electrical phase in a three-phase system. The signs +, − represent the winding direction.

With this measure, it is possible to significantly reduce the first subharmonic in the Fourier decomposition of the magnetomotive force for example, as will be described in detail later.

FIG. 2 shows an embodiment example of a stator in a plan view. For greater clarity, only the two coils that are positioned around the two teeth 4, 5 formed between the first and the third and the first and the second grooves are shown. It can be recognized that the different numbers of turns n1, n2 in the different grooves 1, 2, 3 are achieved by virtue of the fact that the coil enters the stator on a different main side 6 than that from which it exits, namely an opposite side 7. It can also be clearly recognized that the two coils around the two teeth 4, 5 belong to the same phase winding A. The winding is done in such a manner that coils of the same phase winding in a common groove 1 have the same number of turns n1.

The number of turns of the coils in those grooves 2, 3 that contain coils of different phase windings A, B, C is designated by n2.

Whereas FIG. 2 shows a single phase winding A, several phase windings A, B, C are shown in FIG. 3. It can be recognized that there are different phase windings A, C in the third groove 3 and different phase windings A, B in the second groove 2, and that the coils each have the same number of turns n2. It is additionally evident that the coils are wound in such a manner that a current flow in the same direction is achieved in those grooves 1 that are occupied by coils of the same phase winding A, while the coils in the grooves 2, 3 are wound with different phase windings for current flows in the opposite direction in these grooves.

Two adjacent teeth 5, 10 of the stator formed between respective adjacent grooves 1, 2; 2, 14 of the stator have coils of different phase windings A, B and the same winding direction.

The relationship of the first number of turns to the second one for different introduction and exiting of the coils with respect to the main sides of the stator is described as follows:

n1=n2−1 and

50%≦n1/n2<100%.

Due to the adjustable number of turns ratio between 50% inclusively and 100% exclusively, it is possible to reduce the first subharmonic to 0, as is shown for the sake of example in FIG. 10.

One advantage of this principle, as shown for the sake of example in FIGS. 1-3, is that no compensation windings or additional windings are necessary to reduce the first subharmonic.

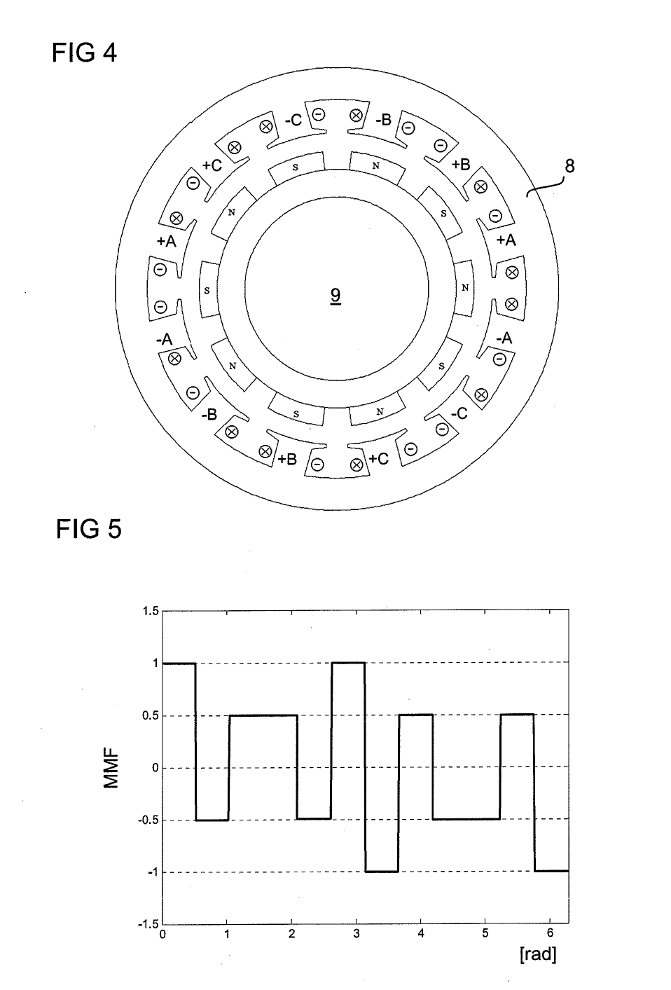

An embodiment is shown in FIG. 4 using a complete stator 8 and rotor 9 of a rotating electric machine. The stator has 12 grooves for example, while the rotor has 5 pole pairs, i.e. 10 poles S, N. The winding topology with concentrated windings is produced according to the following scheme as viewed in the counterclockwise direction: −A, +A, +B, −B, −C, +C, +A, −A, −B, +B, +C, −C.

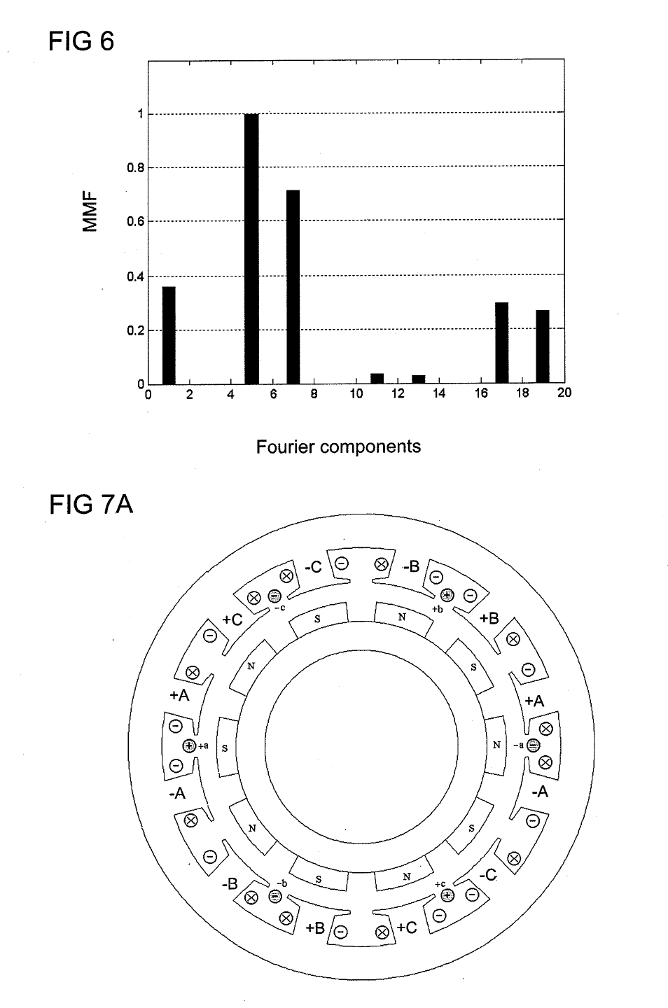

FIGS. 5 and 6 show diagrams of the magnetomotive force MMF plotted versus the angular position in rad and the Fourier components, respectively, for a conventional machine with the topology of FIG. 4, but without the different numbers of turns in accordance with FIGS. 1-3.

It can be recognized that use of the fifth harmonic as the working harmonic is advisable. Undesired harmonics include, in particular, the first and the seventh harmonics. In alternative embodiments, the seventh harmonic can be used as the working harmonic. For the latter case, 14 poles must be provided in the rotor rather than the ten poles that are shown here. The reduction of the first harmonic has great significance particularly with respect to rotor losses.

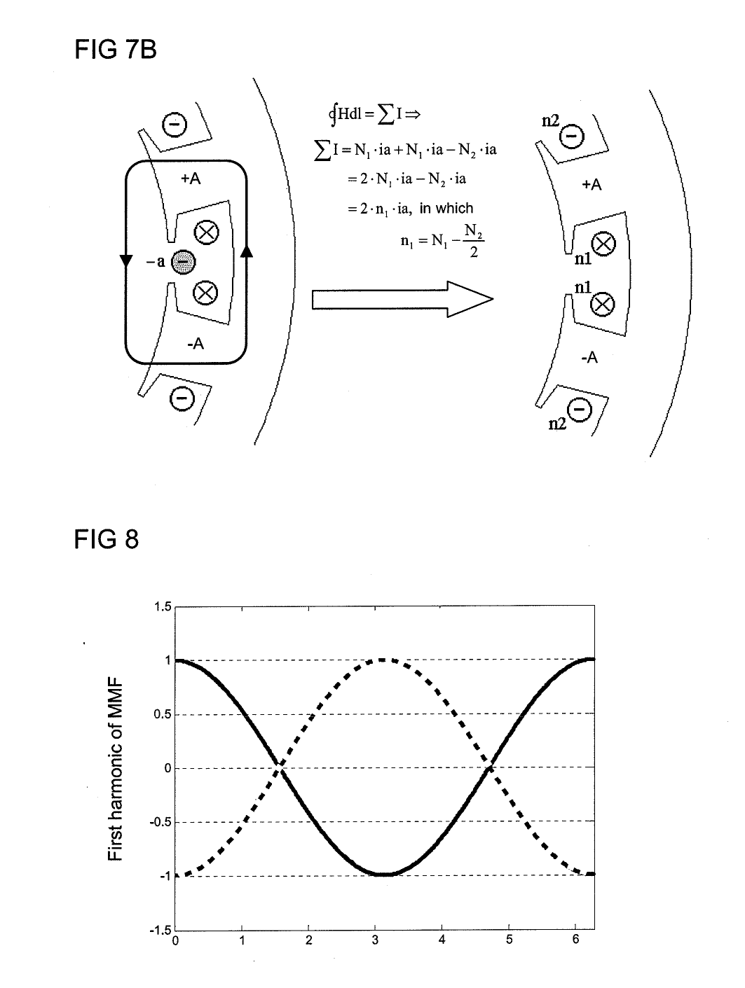

FIG. 7A shows an alternative to the embodiments of FIGS. 1-3, which have different numbers of turns n1, n2. The explanation with reference to FIG. 7A serves for a better understanding of the functional principle.

In FIG. 7A, the main windings each have the same number of turns, as in a conventional 12/10 machine with twelve grooves and ten poles. However, a distributed additional winding is provided, which is placed in every second groove and is used to damp the first subharmonic. This additional winding will also be referred to below as a compensation winding.

The left half of FIG. 7B shows a cutout of this compensation winding, which is labeled there with −a. There are two corresponding additional compensation windings b and c.

The number of turns of the main winding A, B, C is designated as N₁, and the number of turns of the additional windings a, b, c is designated as N₂.

The additional winding according to FIG. 7A yields a magnetomotive force that is configured in such a manner that the first subharmonic according to FIG. 6 is precisely compensated by an opposite component of the magnetomotive force. The resulting first harmonic of the magnetomotive force can be completely eliminated with a special relationship between N1 and N2. This is shown by means of FIG. 10.

This principle of opposing effects is further explained in FIG. 8, in which the solid line describes the first harmonic of the magnetomotive force of the main winding A, B, C of FIG. 7A, while the broken line relates to the first harmonic of the magnetomotive force of the additional winding a, b, c. The opposing effects are evident based on FIG. 8 and have the effect that the first harmonic precisely disappears.

FIG. 7B additionally shows how the winding topology with an additional winding a, b, c according to FIG. 7A and the winding topology shown for the sake of example in FIGS. 1-3 can be converted from one to another. As becomes clear from FIG. 7B, the reduction of the first subharmonic can equivalently be achieved by using coils that have different numbers of turns n1, n2 in different grooves, instead of by using the compensation winding a, b, c. n1 describes the first number of turns of those coils that are placed in grooves that accommodate the same phase winding, whereas n2 describes the second number of turns in grooves that accommodate coils with different phase windings A, B, C.

The conversion of the embodiments according to the left-hand side of FIG. 7B and the right-hand side of FIG. 7B, for the example of the phase winding A and starting from FIG. 7A, can be described by the following mathematics. For the resulting number of turns we have:

$$\begin{matrix}\sum I = N 1 \cdot ia + N 1 \cdot ia - N 2 \cdot ia \\ = 2 \cdot N 1 \cdot ia - N 2 \cdot ia ,\end{matrix}$$

in which N1 designates the number of turns of the main winding, N2 the number of turns of the additional winding, ΣI the sum current in the groove that accommodates the coils of the same phase winding, and is the current of the phase winding A, which also flows in the compensation winding a.

The formula can be rewritten as:

$$\sum I = 2 \cdot n 1 \cdot ia , \\ with$$

$$n 1 = N 1 - \frac{N 2}{2} , \\ in which$$

n1 designates the number of turns of the coils in the grooves that accommodate coils of the same phase winding.

Analogous circumstances apply to the currents ib, ic of the two other phase windings B, C.

The number of turns of the coils in the grooves that accommodate coils of different phase windings, for example the phase windings A, B, analogously results as:

$$\begin{matrix}\sum I = - N 1 \cdot ia + N 1 \cdot ib , \\ = - n 2 \cdot ia + n 2 \cdot ib ,\end{matrix}$$

$$with$$

$$n 2 = N 1 , \\ in which$$

n2 designates the number of turns of the coils in grooves with coils of different phase windings.

The situation is analogous for the phase windings A and C, as well as the phase windings B and C.

By comparison of the two equations, it follows that the first and second number of turns n1, n2 for FIG. 7B must be different. Therefore:

n1≠n2

One therefore recognizes that the embodiment with a different numbers of turns in identical coils but different grooves of these coils is equivalent to the embodiment with compensation windings a, b, c and therefore makes the latter superfluous. It is thus advantageously possible to achieve the desired success with a simple winding construction.

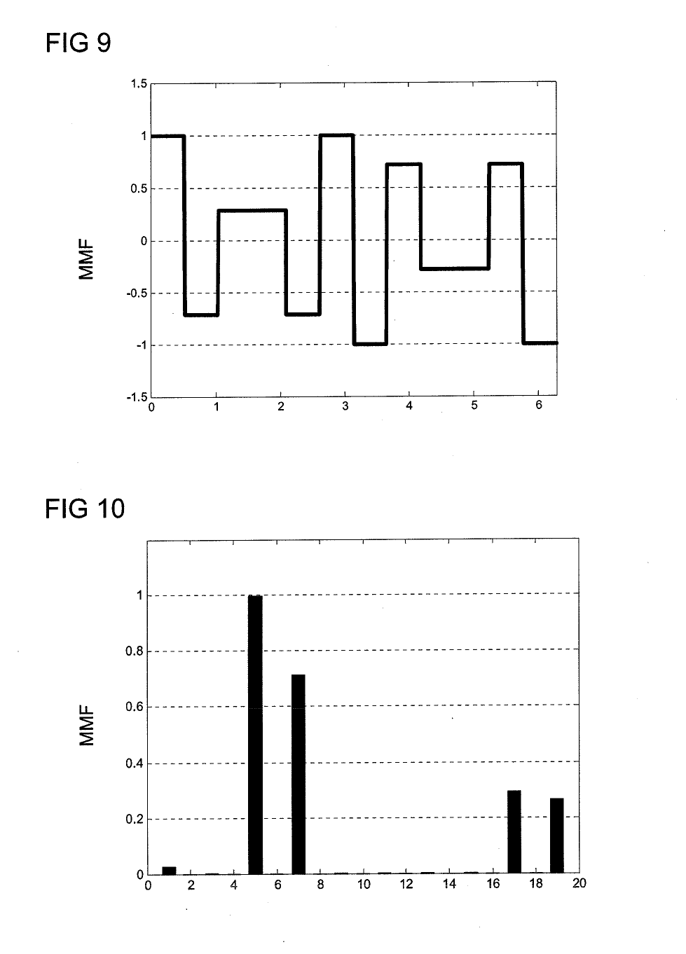

FIGS. 9 and 10 show the distribution of the magnetomotive force versus the angular position in rad and the decomposition of the Fourier components, respectively. These FIGS. 9 and 10 apply equally well to the embodiments according to FIG. 7A and the left-hand side of FIG. 7B and to the embodiments according to the right-hand side of FIG. 7B and FIGS. 1-3.

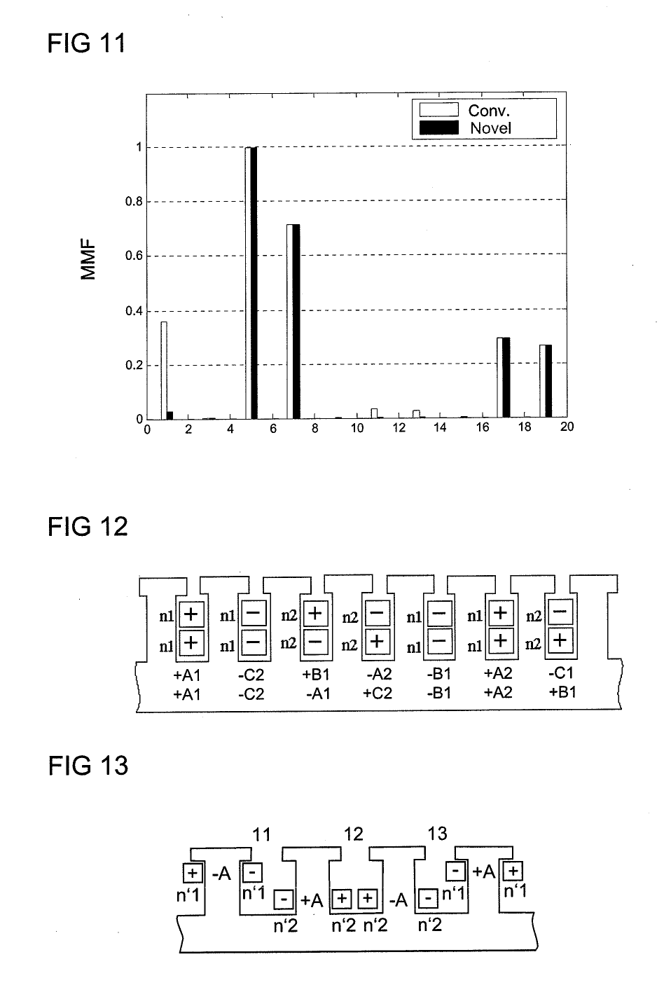

FIG. 11 shows a comparison of the diagrams from FIGS. 6 and 10.

FIG. 12 shows a refinement of the principle that is illustrated for the sake of example by FIG. 1. Here, the principle of a 12/10 topology of the electric machine is transferred to a 24/10 topology, which relates to a winding topology with 24 grooves and 10 poles. Here too, the subharmonic can be reduced to 0 with a defined relationship of the first number of turns n1 to the second number of turns n2.

In previous embodiments, it was illustrated for the sake of example that the reduction of the subharmonic based on the 12 groove/10 pole winding topology can be achieved by placing different numbers of turns of the respective identical coil in different grooves. Thereby the additional winding a, b, c shown with FIG. 7A can be avoided.

A different effective number of turns, however, can alternatively also be achieved by an additional concentrated winding as shown on the basis of FIG. 13. Only the phase winding A will initially be shown for the sake of simplicity. The number of turns of the main winding is designated as n′2, while the number of turns of the concentrated additional winding is designated as n′1.

FIG. 13 illustrates that the resulting number of turns in the grooves 11 and 13 is increased by more than half of the number of turns of the intermediate groove 12. For a defined ratio between the number of turns n′2 of the main winding and the number of turns n′1 of the concentrated additional winding, the first harmonic of the magnetomotive force resulting from the overall winding topology can be reduced to 0 or nearly 0.

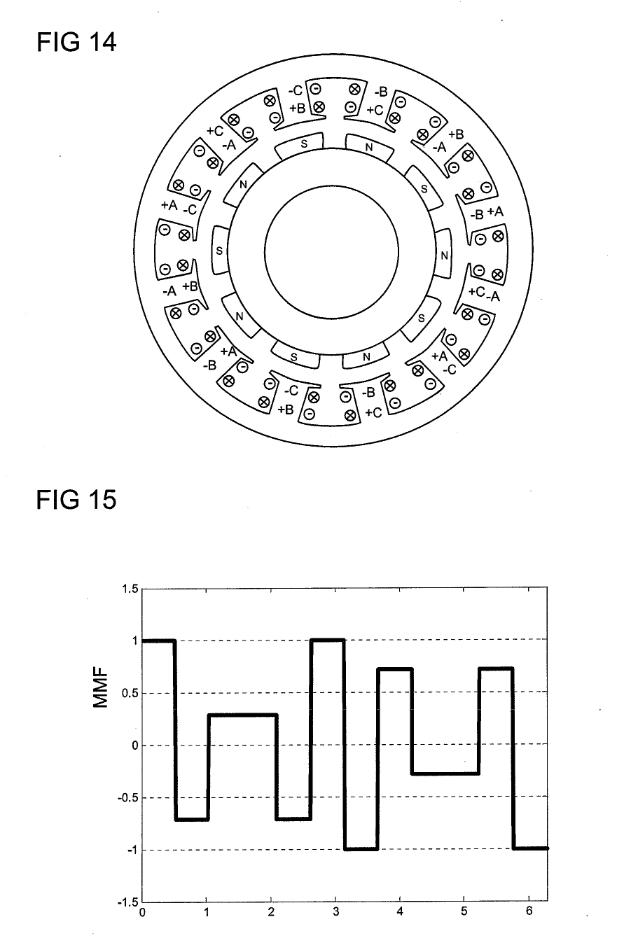

FIG. 14 shows the complete winding topology of the principle from FIG. 13 for a rotating electric machine with 12 grooves and 10 poles. There are different numbers of windings, as assumed but not explicitly shown in FIG. 13.

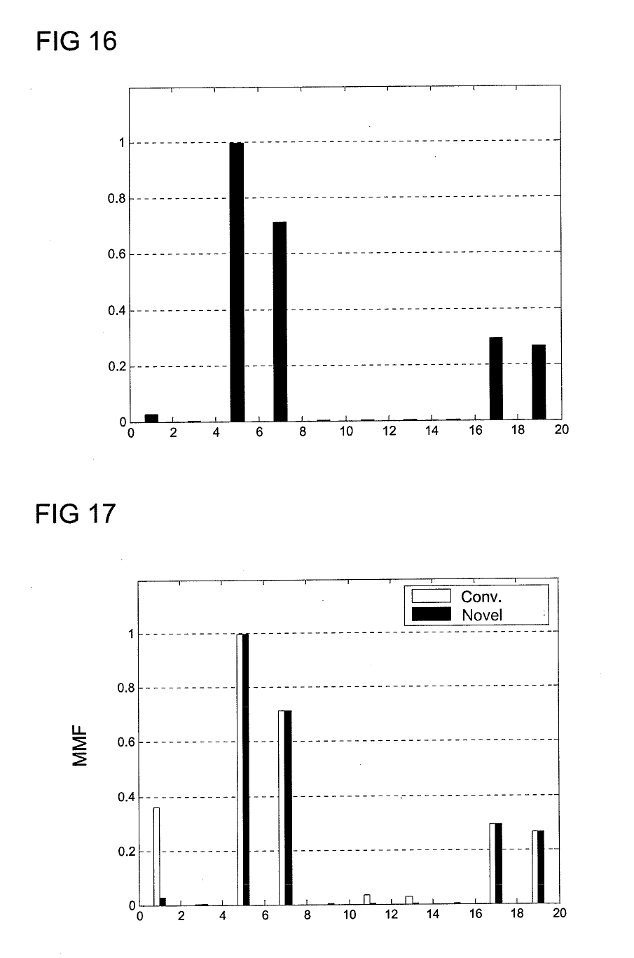

FIGS. 15 and 16 show the magnetomotive force plotted versus the angular position in rad and the Fourier components of the corresponding decomposition, respectively, with respect to the embodiment example of FIG. 14.

FIG. 17 shows a comparison regarding the diagrams of the Fourier decompositions of the magnetomotive forces. The embodiments according to FIGS. 16 and 6 are compared in this case.

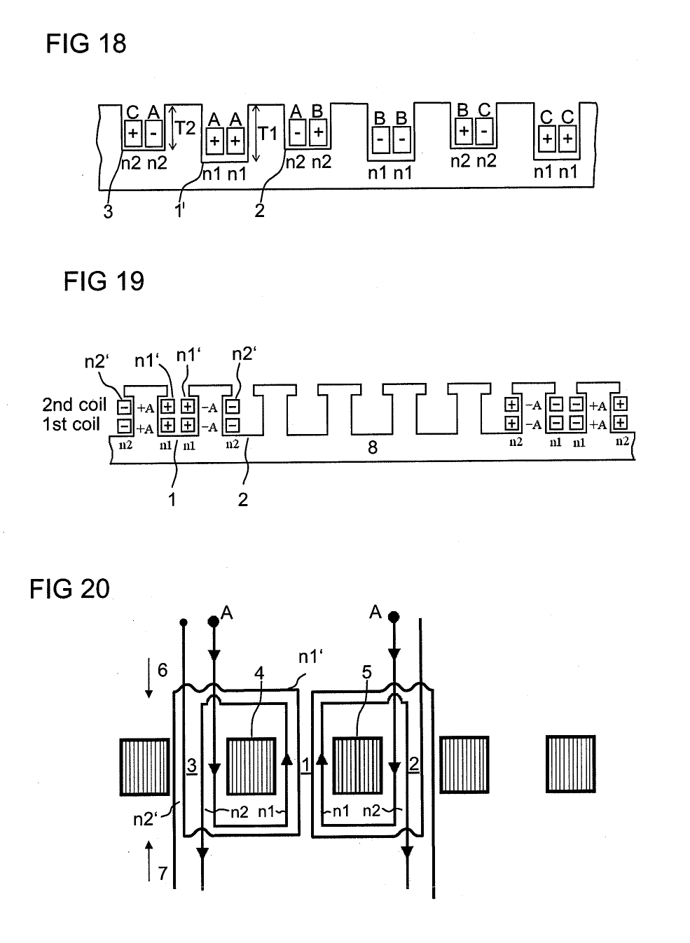

FIG. 18 shows an example of a refinement of FIG. 1 in which the grooves are formed with different depths. The second and third grooves 2, 3 have a depth T2 unchanged from the embodiment according to FIG. 1. The first groove 1′, however, has a depth T1 that is greater than the depth of the second and third grooves 2, 3.

In general, all grooves in FIG. 18 with coils of the first number of turns n1 are formed in this respective groove with greater depth T1.

Thereby a reduction of the fundamental wave can be achieved.

Alternatively to the embodiment shown in FIG. 18, it would be possible, in an embodiment not shown here, for the first groove 1 based on FIG. 1 to have an unchanged depth, and for the depth of the second and third grooves to be increased.

In this way it would be possible, due to the higher number of turns n2 in the second and third grooves, to achieve the same current density as in the first groove 1.

Alternatively or additionally, it would be possible for the respectively deeper groove to be used for cooling, by providing a cooling groove, for example.

Additional possibilities for achieving a mechanical barrier for the magnetic flux are specified in the application DE 10 2008 054 284.9, which is incorporated in full herein by reference in this respect.

FIG. 19 shows an embodiment example of the stator with two superimposed coils according to the proposed principle. The reader is referred to the description of FIG. 1. Above the layer of coils described in the latter, referred to below as the first coil layer, a second layer of coils is provided. In other words, a second coil, preferably arranged above the first coil in the radial direction, is provided according to the proposed principle. The first and second coils are preferably wound around the same tooth of the stator.

The number of turns n1 of the first coil in the example of FIG. 19 is equal to the first number of turns n1′ of the second coil. The second number of turns n2 of the first coil is likewise equal to the second number of windings n2′ of the second coil.

The total number of turns in those grooves 1 that accommodate coils of identical phase will be designated below as n1*, and n2* will designate the total number of turns in the grooves 2 that accommodate coils of different phases.

The relationship between the first number of turns n1 and the second number of turns n2 for each coil reads:

$${n}_{1} = {n}_{2} - 1 , \\ and$$

$$50 \% \leq \frac{{n}_{1}}{{n}_{2}} < 100 \%$$

On the other hand, the relationship between the total numbers of windings n1*, n2* is described as follows:

$${n}_{1}^{*} = {n}_{2}^{*} - 2 , \\ and$$

$$50 \% \leq \frac{{n}_{1}^{*}}{{n}_{2}^{*}} = \frac{2 {n}_{1}}{2 {n}_{2}} < 100 \%$$

The two equations above show that, although the total number of turns per phase is increased by a factor of 1, an effective reduction of the first subharmonic is nevertheless achieved. It was also shown that the difference between the total number of turns in the two grooves 1, 2 corresponds to the number 2.

FIG. 20 shows an example of coils constructed one above the other according to the proposed principle in a plan view. It can be recognized that the numbers of turns in the two grooves in which a coil is arranged are different. This is achieved by virtue of the fact that the coils enter the groove on one side of the stator but exit on the other side of the stator. This applies to the first and the second coils.

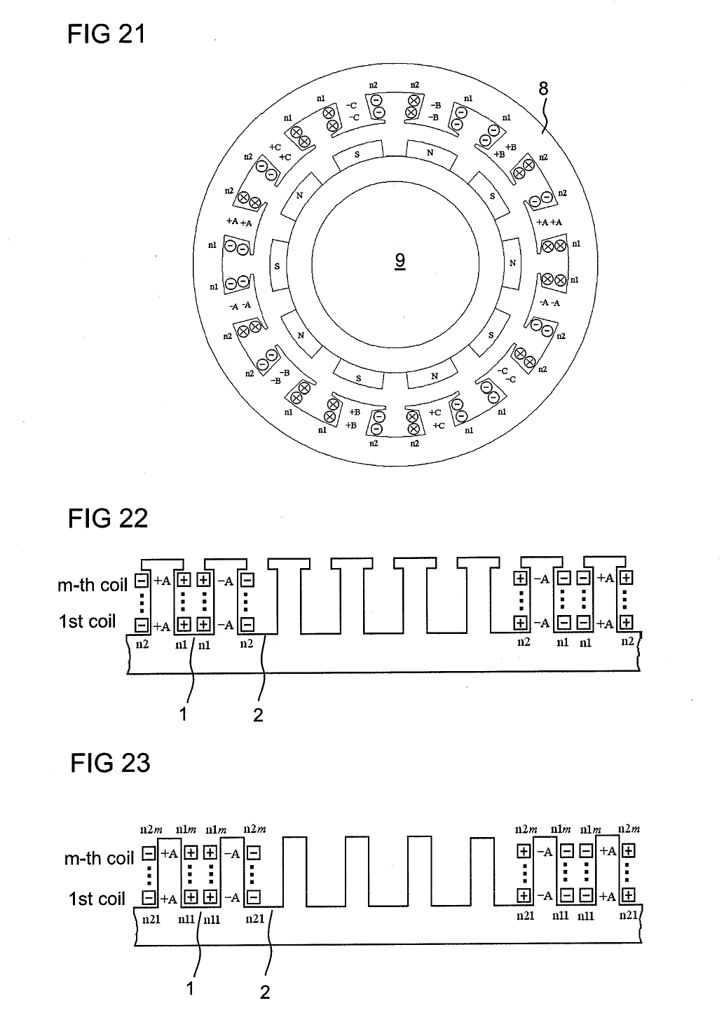

FIG. 21 shows an example of an electric machine with a rotor 9 and a stator 8 with several coils arranged one above another according to the proposed principle. The example shows a stator with 12 teeth and 12 grooves as well as a rotor with 10 poles. The rotor comprises 5 pole pairs of opposing permanent magnets.

Corresponding to the embodiment with two coils per tooth shown by means of FIGS. 19-21, it is also possible for more coils per tooth to be provided. This generalization to m coils per tooth will be considered below.

FIGS. 22 and 23 each show a refinement of the embodiment according to FIG. 19 with more than two coils arranged one above another according to the proposed principle. First, FIG. 22 will show the case in which the first, the second and so on up to the m-th coil each have the same first number of turns and the same second number of turns. These will continue to be designated n1 in the first groove and n2 in the second groove.

FIG. 22 also shows only one phase winding, namely phase winding A, in order to explain the basic principle. The additional phase windings B, C of a three-phase machine are constructed analogously.

As in FIG. 19 above, the coils of equal phase in FIG. 22 that are wound around a common tooth can be connected electrically in series or in parallel.

As in FIG. 19, the total number of turns in those grooves 1 that accommodate coils of identical phase is designated as n1*, and n2* designates the total number of turns in the grooves 2 that accommodate coils of different phases.

Thus the relationship between the first number of turns n1 and second number of turns n2 is unchanged:

$${n}_{1} = {n}_{2} - 1 , \\ and$$

$$50 \% \leq \frac{{n}_{1}}{{n}_{2}} < 100 \%$$

On the other hand, the relationship between the total numbers of windings n1*, n2* for coils 1 to m is described as follows:

$${n}_{1}^{*} = {n}_{2}^{*} - m , \\ and$$

$$50 \% \leq \frac{{n}_{1}^{*}}{{n}_{2}^{*}} = \frac{m \cdot {n}_{1}}{m \cdot {n}_{2}} < 100 \%$$

Although the total number of turns per phase is increased by a factor of m, the formula listed above shows that an effective reduction of the first subharmonic is achieved. The difference of the total number of turns between the grooves of a coil is m.

In each of the latter-described examples it was assumed that the coils have the same number of turns per coil, but different numbers of turns per coil in different grooves.

To increase the flexibility, it is also possible, however, to configure the number of turns per coil differently.

The relationships arising in this case will be described below using the example of FIG. 23. It is again assumed that a total of m coils are wound per tooth. FIG. 23 shows the winding distribution of a machine with 12 teeth and 10 poles having m coils per tooth, with a different number of turns for each coil and with coils having different numbers of turns in the respective grooves.

As in FIG. 19, the total number of turns in those grooves 1 that accommodate coils of identical phase is designated as n1*, and n2* designates the total number of turns in the grooves 2 that accommodate coils of different phases.

For the relationship of the first number of turns n1k and the second number of turns n2k it holds that:

$${n}_{1 k} = {n}_{2 k} - 1 , \\ and$$

$$50 \% \leq \frac{{n}_{1 k}}{{n}_{2 k}} < 100 \%$$

$$k = 1 , 2 , 3 , … , m$$

The relationship between the total number of turns n1* and the total number of turns n2* in different grooves for the respective m coils is described by the following mathematics:

$${n}_{1}^{*} = {n}_{2}^{*} - m , \\ and$$

$$50 \% \leq \frac{{n}_{1}^{*}}{{n}_{2}^{*}} = \frac{{\sum }_{k = 1}^{m} {n}_{1 k}}{{\sum }_{k = 1}^{m} {n}_{2 k}} < 100 \%$$

The application of the described principle is not limited to the embodiment examples that are shown.

Instead, winding topologies with differing numbers of turns per groove of a coil can be used in order to improve the magnetic properties of other types of windings as well. As examples, one can mention two-phase, three-phase or multiphase windings.

The illustrated principle is likewise applicable to different concentrated windings or different distributed windings.

Windings according to the proposed principle can be used in a very wide variety of types of electric machines This includes, for example, asynchronous machines with a wound rotor, a cage rotor or a solid rotor as well as synchronous machines with a permanent magnet rotor, a reluctance rotor, a separately excited rotor, a hybrid rotor, etc.

In particular, the refinements of FIGS. 12-18 can be combined with the proposed principle according to FIGS. 19-23.

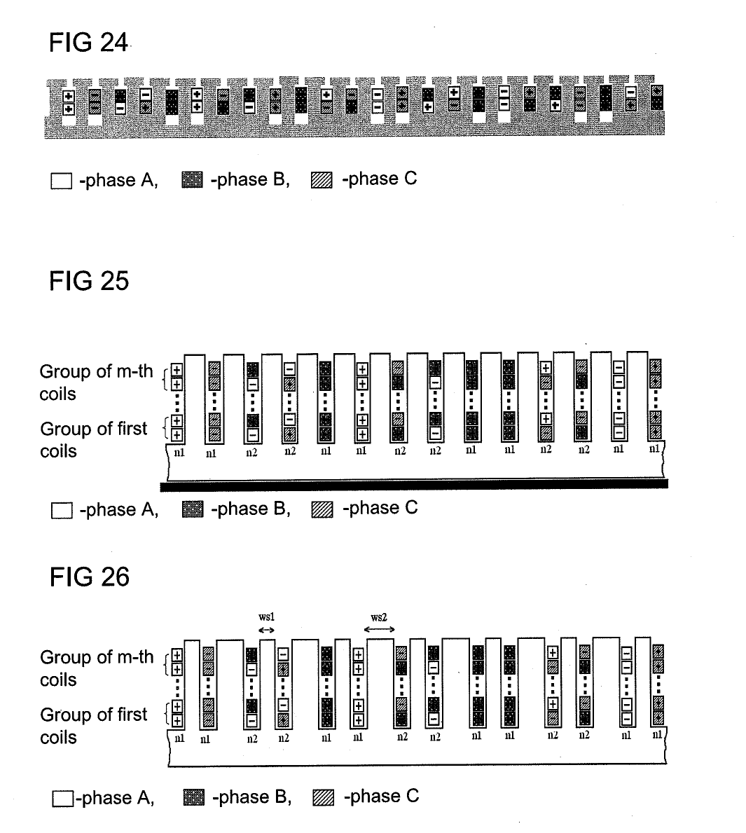

FIG. 24 shows an embodiment of a stator in 24/10 topology, i.e. with 24 grooves in the stator and 10 poles in the rotor, not shown here. Alternatively, a rotor with 14 poles can also be used.

Barriers for the magnetic flux in the stator are also provided. These barriers are each constructed by means of an increased groove depth. Those grooves that accommodate coils of the same phase winding have an increased groove depth. On the other hand, those grooves that accommodate coils of different phase windings are constructed with a conventional groove depth. Three phase windings A, B, C, shown with differing cross-hatching, are provided for a three-phase machine.

FIG. 25 specifies an embodiment example of a stator that results from combining the embodiments of FIGS. 12 and 22. The embodiment has a 24/10 topology. Several levels of coils arranged one above another as shown in FIG. 22 are also provided in FIG. 25. A lowest layer comprises first coils, and an uppermost layer m-th coils. Departing from FIG. 22, however, the number of grooves is increased to 24 grooves versus a topology with 12 grooves, the stator continuing to be designed for cooperation with a rotor having 10 poles. Thus each plane of first, second through m-th coils is constructed as a group of two sublevels, each comprising two offset 12/10 winding topologies arranged one above the other.

FIG. 26 shows an embodiment example of a refinement of the stator according to FIG. 25 with different tooth widths. Those teeth that are formed between grooves with equal first number of turns n1 have a first tooth width ws1. Those teeth that are formed between grooves with identical second number of turns n2 likewise have the first tooth width ws1. On the other hand, those teeth that are formed between grooves with different numbers of turns n1, n2 have a second tooth width ws2. The second tooth width ws2 is greater than the first tooth width ws1. The tooth width is measured along the stator in the running direction of the rotor.

### LIST OF REFERENCE NUMBERS

1 First groove
1′ First groove
2 Second groove
3 Third groove
4 Tooth
5 Tooth
6 First main side
7 Second main side
8 Stator
9 Rotor
10 Tooth
11 Groove
12 Groove
13 Groove
14 Groove
A Phase winding
B Phase winding
C Phase winding
a, b, c Phase windings of the additional distributed winding
+, − Winding direction
k Index
m Number of coils (groups)
n1, n1′ First number of turns
n2, n2′ Second number of turns
N1 Number of turns of the main winding
N2 Number of turns of the additional winding
n′1 Number of turns of the concentrated additional winding
n′2 Number of turns of the main winding
T1 First groove depth
T2 Second groove depth
ws1 First tooth width
ws2 Second tooth width
n1*, n2* Total number of turns
n1k First number of turns
n2k Second number of turns

1. An electric machine, comprising:
a stator comprising grooves for accommodating coils of an electrical winding; and
a rotor that is movable relative to the stator, wherein a first coil has a first number of turns in a first groove,
wherein the first coil has a second number of turns in a second groove, which is different from the first number of turns of the first coil,
wherein a second coil has a first number of turns in the first groove, and
wherein, the second coil has a second number of turns in the second groove which is different from the first number of turns of the second coil.

2. The electric machine according to claim 1, wherein the first coil and the second coil are from the same phase winding.

3. The electric machine according to claim 2, wherein the first coil and the second coil are connected to one another in series or in parallel.

4. The electric machine according to claim 1, wherein
the first number of turns of the first coil is equal to the first number of turns of the second coil and the second number of turns of the first coil is equal to the second number of turns of the second coil.

5. The electric machine according to claim 1, wherein at least one third coil is provided that has a first number of turns in the first groove and a second number of turns in the second groove.

6. The electric machine according to claim 1, wherein the stator has two opposite main sides for contacting the electrical winding, wherein a first connection of the coils is formed on a first main side among the opposite main sides and a second connection of the coils is formed on a second main side among the opposite main sides.

7. The electric machine according to claim 1, wherein an additional coil with the first number of turns is provided in the first groove and wherein an additional coil with the second number of turns is provided in the second groove.

8. The electric machine according to claim 7, wherein the coils in the first groove are from the same phase winding and the coils in the second groove are from different phase windings.

9. The electric machine according to claim 8, wherein the stator is constructed as a stator with concentrated windings, wherein two adjacent teeth of the stator that are formed between respective adjacent grooves of the stator are provided with coils of different phase windings and identical winding direction.

10. The electric machine according to claim 1, wherein the stator has a three-phase winding comprising three phase windings, each assigned to one electrical phase.

11. The electric machine according to claim 1, wherein the stator is constructed as a stator with concentrated windings, wherein two adjacent teeth of the stator that are formed between respective adjacent grooves of the stator are provided with coils of a phase winding and opposite winding direction.

12. The electric machine according to claim 1, wherein the ratio of the number of grooves of the stator to the number of magnetic poles in the rotor is 12/10 or 12/14 or respective integer multiples of the number of grooves and the number of poles.

13. The electric machine according to claim 1, that comprises one of the following types: a linear machine, axial flux machine, radial flux machine, asynchronous machine or synchronous machine.

14. The electric machine according to claim 1, that is constructed as a machine with an internal rotor or as a machine with an external rotor.

15. The electric machine according to claim 1, wherein the rotor comprises one of the following types: cage rotor, multiple-layer rotor, permanent magnet rotor, rotor with buried magnets, electrically supplied rotor, in particular non-salient pole rotor, salient pole rotor, heteropolar rotor or homopolar rotor.

16. The electric machine according to claim 1, wherein the first groove has a first groove depth that is different from a second groove depth of a second groove.

17. The electric machine according to claim 1, wherein the first number of turns of the first coil is different from the first number of turns of the second coil and/or the second number of turns of the first coil is different from the second number of turns of the second coil.

18. The electric machine according to claim 1, wherein those teeth that are formed between grooves with an equal number of turns have a first tooth width, and those teeth that are formed between grooves with different numbers of turns have a second tooth width.

19. The electric machine according to claim 12, wherein the number of grooves is doubled for a given number of poles.
